(19) United States
(12) Patent Application Publication
(10) Pub. No.: US 2009/0235168 A1
(43) Pub. Date: Sep. 17, 2009

(54) USER MEDIATED EMBEDDED HELP SYSTEM

(76) Inventor: Colin Raymond Dawson, Baulkham Hills (AU)

Correspondence Address: KNOBBE MARTENS OLSON & BEAR LLP, 2040 MAIN STREET, FOURTEENTH FLOOR, IRVINE, CA, 92614, US

(21) Appl. No.: 12/049,214

(22) Filed: Mar. 14, 2008

(51) Int. Cl. G06F 3/00

(52) U.S. Cl. 715/708

(57) ABSTRACT

An embedded help system for a software application; said facility providing embedded help data to a user in response to a help query from said user; said embedded help data comprising base embedded help data and user added embedded help data; said embedded help data pertinent to the operation of said software application.

The present invention relates to an embedded help system and, more particularly, to a user mediated form of such a system.

### BACKGROUND

Various forms of directly accessible help data are available in many computer programs and computerised devices available today. The help data can be stored locally or can be accessed over a network (for example the internet). For example U.S. Pat. No. 6,421,065 assigned to Microsoft Corporation describes a form of online help where the window relating to the help data is split into a navigational frame and a contents pane.

A particular form of access to and display of help data is known as embedded help. In the case of embedded help the help data is embedded in the application window to which the content of the help data pertains. A feature of embedded help (as defined in this specification) is that the help data is always present in the relevant application window to which the help data pertains. The above-referenced U.S. Pat. No. 6,421,065 describes the more generalised form of help data display rather than the quite specific embedded help form of data display.

For it to be useful, help data must be pertinent to the context in which it is displayed and must be clear and accurate. In many practical contexts, help data is not always as clear, accurate or indeed pertinent as one might like. In part this can be due to the help data having been written and installed at the time the application to which it pertains was first written. That is, the initial help data is written in a generic “one size fits all” form in most instances. As such the writer would not have the experience of actual use of the application in conjunction with this help data. Nor can any one writer have the perspective which each and every subsequent user of the application and its help data will have. It is postulated that only through use by multiple users over time is the true clarity and accuracy of the help data able to be gauged.

It is emphasised that each users' circumstances are unique to their environment. Typically any customisation that they may want to make will only be meaningful in their environment.

It is an object of the present invention to address or at least ameliorate some of the above disadvantages.

### Notes

1. The term “comprising” (and grammatical variations thereof) is used in this specification in the inclusive sense of “having” or “including”, and not in the exclusive sense of “consisting only of”.
2. The above discussion of the prior art in the Background of the invention, is not an admission that any information discussed therein is citable prior art or part of the common general knowledge of persons skilled in the art in any country.

### BRIEF DESCRIPTION OF INVENTION

Definitions

Embedded Help: Embedded help is a particular form of help data where the data is always present and on view in association with the application window to which it pertains. In effect, it is always readily available to the user—it does not require the user to trigger a separate program sequence as, for example, by selecting or clicking on a help button or a hyperlink (that would then take the user to the help data). Embedded help is help data that appears within an application rather than in a separate help data window. An early example of embedded help occurred in the program Microsoft Money 99. In that program, when the user selects “help topics” from the help menu the Money 99 help data attaches to the right hand side of the application window. Once selected, it is “always there.” Embedded help in accordance with this definition is embedded in the user interface. It is not provided in a separate window. From this is follows that the embedded help content always stays in sync in the current context.

User: operator or viewer of a software application (including internet-based), system or machine.

Location: A particular page or screen in a software application or web page, or a particular configuration or status in a system such that it triggers display of specified embedded help content.

Managed content: content can be controlled throughout all stages of production and creation, covering authoring, editing, removal, revealing or hiding. This control may be exercised by either individual users or at a group level by a manager as appropriate for the particular environment and the type of content.

Accordingly in one broad form of the invention there is provided an embedded help system for a software application; said facility providing embedded help data to a user in response to a help query from said user; said embedded help data comprising base embedded help data and user added embedded help data; said embedded help data pertinent to the operation of said software application.

Preferably said software application includes a user interface and said embedded help data is embedded in said user interface.

Preferably said user added help data is merged with said base help data.

Preferably said user added help data comprises one or more distinct contributions.

Preferably said software application can be perceived by said user as comprising a set of one or more contextual locations

Preferably said help data attaches to selected ones of contextual locations whereby said help data is pertinent to said contextual locations.

Preferably said user added help data remains distinct from said base help data.

Preferably individual contributions to any given location can be viewed in isolation from each other.

Preferably each contribution has a pertinent title and summary word or phrase that is constructed as a hyperlink which when activated allows access to the body of the contribution.

Preferably said title is merged into the existing set of hyperlinks that are used for navigation in the online help.

Preferably said hyperlinks control which, if any, user-created content is displayed.

Preferably contributions are merged such that their display is consistent with the existing content.

Preferably each user contribution is controlled in isolation from default on base help data such that the system can restrict access to said contribution based on user or group permissions.

Preferably said system can be configured to give or withhold permission for users or groups to create new contributions.

Preferably presentation and management is an integral part of said application.

Preferably said help data is maintained separately from the executable code of said application.

Preferably a contributor of said help data uses said application and notes the page name at each context of entry of said help data thereby to match by way of a key said help data with said application within said context thereby to permit addition of said help data to said application independent of the writing of said executable code of said application.

In a further broad form of the invention there is provided a method for enabling users of embedded online help data to merge new content or user added help data into the help data; said embedded online help data comprising help data embedded in a user interface of an application.

Preferably users of online help embedded into a device or software can create new help content that is merged with the existing help content.

In a further broad form of the invention there is provided method for provision of help data to a user of an application; said method comprising display of base help data embedded in an application window; said base help data pertinent to the context of said application; permitting said user to add user added help data to said application window subject to user permission.

Preferably said user permission is based on role of said user.

Preferably said user added help data is provided as a first component and a second component; said first component hyperlinked to said second component.

In a further broad form of the invention there is provided memory having a computer program stored therein, said computer program capable of being used in connection with an application; said application displayable in a window on a display driven by a processor in communication with said memory; said memory comprising:
a first memory portion physically configured in accordance with computer program instructions to display help data embedded in an application window; a second memory portion physically configured in accordance with computer program instructions that will enable a user of said application to open an editing window for editing of user added help data; said application window comprising a video image of a display; said processor driving said display so as to present help data and user added help data derived from said user together in said application window.

In a further broad form of the invention there is provided a data sequence comprising a base help code sequence which is linked in computer memory with a user added code sequence for display in an application window; said user added code sequence generated by an editor program which opens in said application window on instruction from said user.

### BRIEF DESCRIPTION OF DRAWINGS

Embodiments of the present invention will now be described with reference to the accompanying drawings wherein:

FIG. 1 is a time series of diagrammatic screen shots of an application window with an instance of embedded help displayed in accordance with a first preferred embodiment of the invention,

FIG. 2 is a flow chart of the logic for a single user community which generates the display of FIG. 1.

FIG. 3 is a screen shot of a particular instance of the embedded help system of FIG. 1.

FIG. 4 is a further screen shot of a particular instance of the embedded help system of FIG. 1.

FIG. 5 is a further screen shot of an instance of the embedded help system of FIG. 1.

FIG. 6 is a block diagram of a system which may implement the display sequence of the embodiment of FIG. 1.

FIG. 7 illustrates an application of the system of FIG. 1 to a handheld device such as a PDA (Personal Digital Assistant) or the like,

FIGS. 8A, 8B comprise screen shots of examples of embedded help in accordance with an embodiment of this invention applied to the PDA of FIG. 7

FIG. 9 comprises a screenshot of an application window with help data embedded in the user interface of that application window in accordance with a further embodiment of the present invention.

FIGS. 10A, 10B, 10C comprise a specific example of an embedded user mediated addition sequence exemplifying the system of FIG. 1.

### DETAILED DESCRIPTION OF PREFERRED EMBODIMENTS

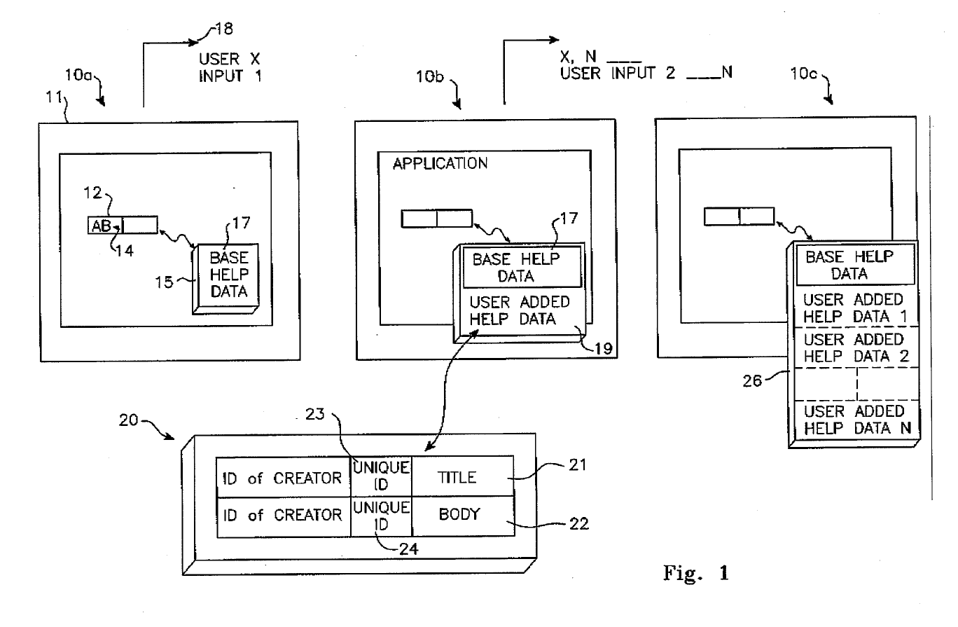

With reference to FIG. 1, there is illustrated a diagrammatic screenshot series 10a, b, c of instances of embedded help in accordance with a first preferred embodiment of the invention.

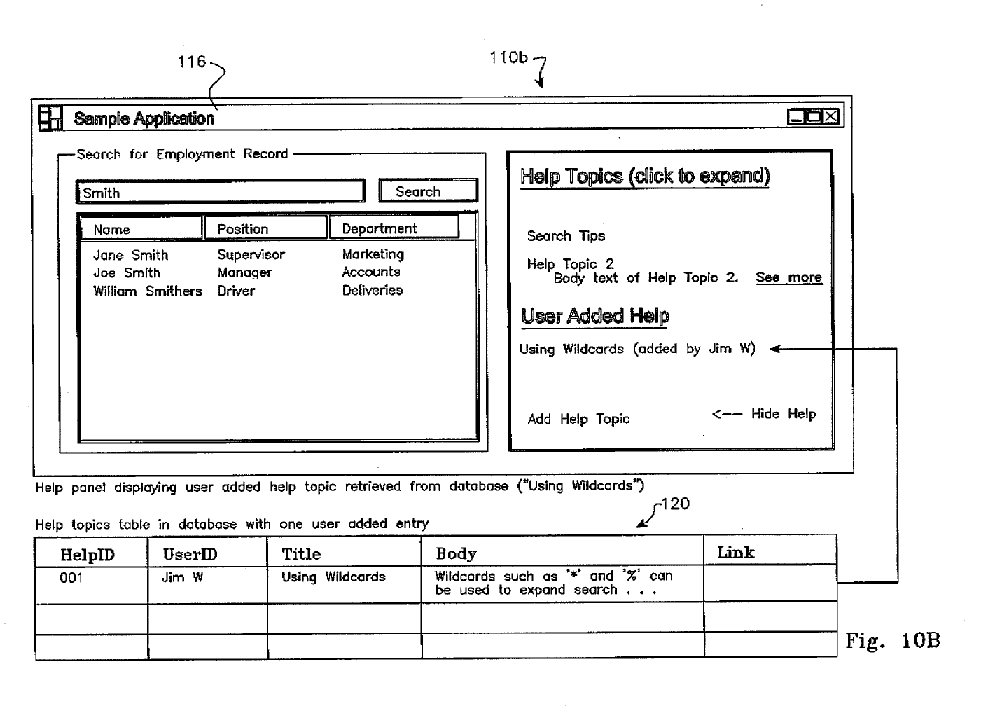

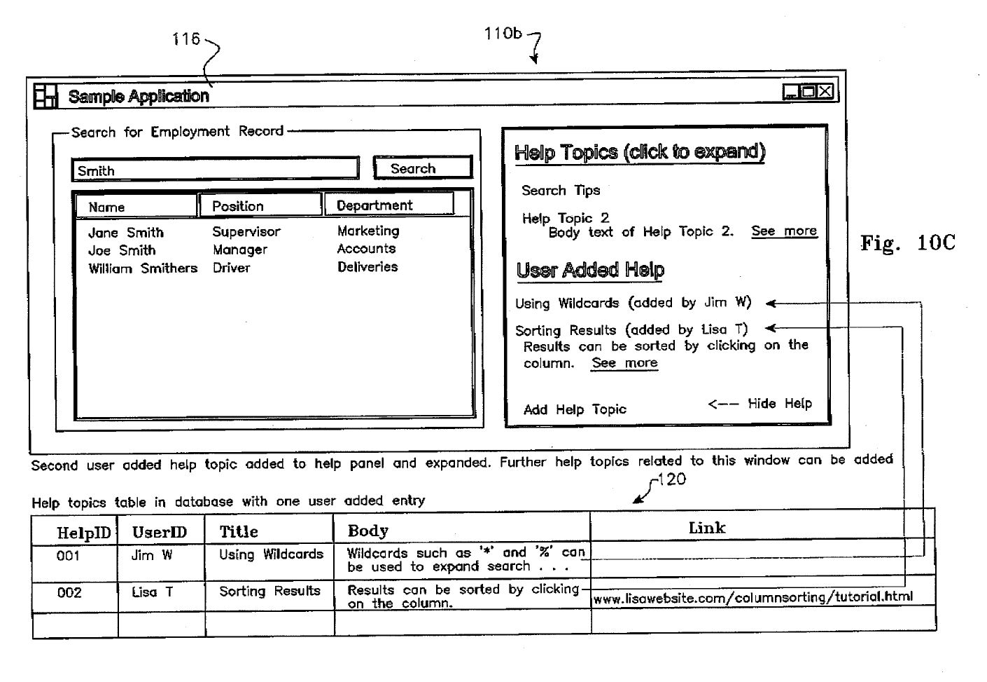

FIG. 10a illustrates a screen 11 displaying an application 12 within a user interface or application window 16. In this instance the application 12 displays a data field 13 with an adjacent help window 15. In this instance the help window 15 contains base help data 17. The base help data 17 is pertinent to data field 13 within application 12 and all displayed within the one window 16. In this instance the base help data 17 is help data which has been constructed at the same time that application 12 has been programmed.

In the course of using application 12 a user X (not shown) may formulate additional thoughts in response to their viewing of the base help data 17 with a view to, for example, amplifying the base help data 17 and its relevance to data field 13 at least from the perspective of user X. In this event user X may initiate user X's input 18 in the form of user X added help data 19, as illustrated in Screenshot 10b.

In the course of creating the user-added help data 19 in Screenshot 10b a user added help data sequence 20 will be created and stored in association with the application 12. As illustrated diagrammatically in FIG. 1, the user added help data sequence 20 will include a Title 21 (being a brief indication of the substance of the user added help data 19), a Body 22 (which will hold the substance of the user added help data 19), a unique Title ID 23, a unique Body ID 24 and a unique Creator ID 25 associated respectively with Title 21 and Body 22. This data sequence 21 allows significant control over the user added help data 19 in the context of the application 12 and those users who may utilise the application 12 and who may seek to view and in at least some instances add further user added help data 19.

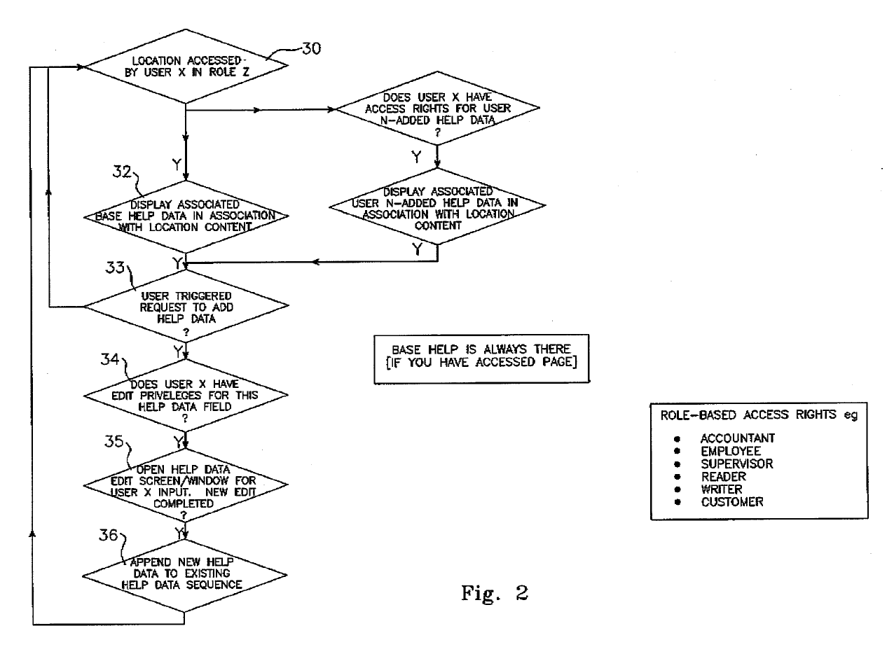

With reference to Screenshot 10c of FIG. 1, user X or indeed a different user, N, may seek to add an additional item of user added help data 26. This additional item of user added help data 26 can be added in the same way as user added help data 19 has been added with reference to Screenshot 10b of FIG. 1. The logic of access by user X to help data and the ability to add user added help data is illustrated in the flow chart of FIG. 2.

Associated with application 12 will be code which monitors user access to application windows 16 as indicated in step 30.

If the user X elects to access help data then, as indicated in logic portion 32 the base help data 17 based on context is displayed to user X.

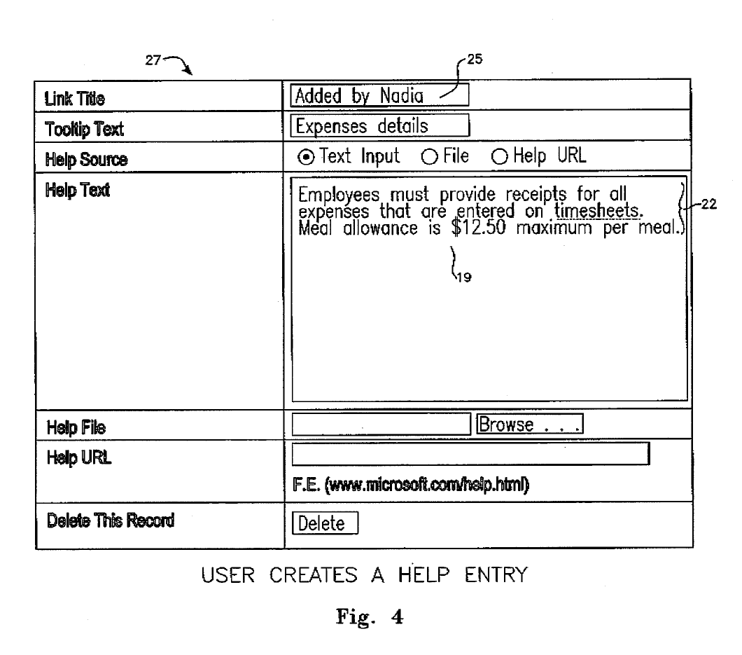

If user X elects to add user added help data 19 (refer to Screenshots 10a, 10b of FIG. 1) then logic item 33 determines the issue of whether user X has edit privileges (logic box 34). In a preferred form edit privileges are granted based on role as described further below. If user X does have edit privileges then an edit screen or Window 27 (refer FIG. 4) is opened in order to allow user X to enter user added help data 19. Once the code determines that the edit is completed (logic box 35 of FIG. 2) then the user added help data 19 is appended to the existing help data sequence which, in this instance, comprises the base help data 17 (logic box 36).

As will be further observed in respect of the logic diagram of FIG. 2, the user added help data sequence 20 allows the code associated with application 12 to exert a high degree of selectivity or control over which items of help data a given user N has access to and also the same high level degree of control or selectivity over which items of help data can be edited by a user N.

In a particular preferred form access rights for the purposes of reading and/or writing are determined by context (or location) and role rather than detailed user permissions as might be expected within an operating system.

In a preferred embodiment, access for any given user X to a particular application and thence to the associated base help data is determined by role. So, for example, a member of the employees group will have access to all applications and base help data that all of the employees within a particular work group have permissions to access. However the user X may have more than one role. So, for example, an employee may also have the role of an accountant. The accountant role may allow access to a different set of base help data. In a preferred form where a user has more than one role the help context which is displayed be based on a defined hierarchy. For example when the user is both an employee and an accountant the accountant role will outrank the employee role so that accountant specific help data will be displayed.

Similarly, write permissions (the ability to add user mediated help data), in a preferred embodiment, is determined by role.

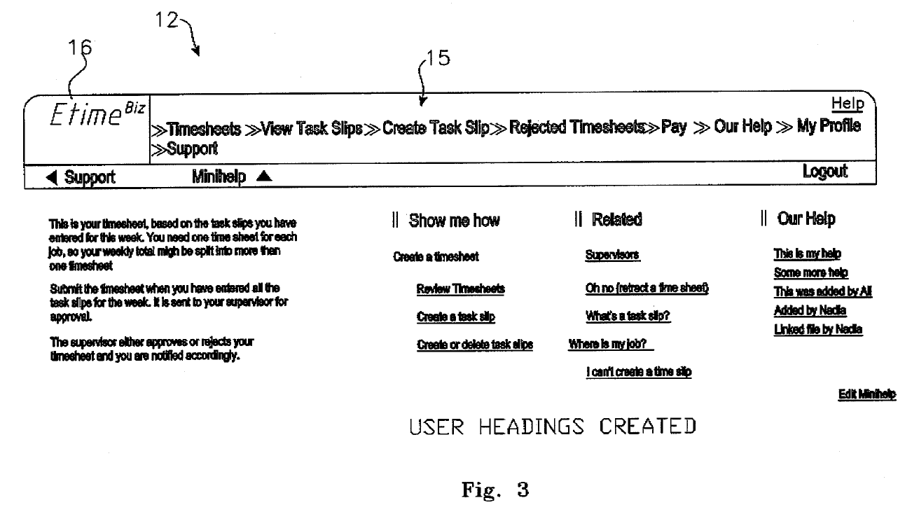

With reference to FIGS. 3, 4 and 5, the user access and editing sequence that has been described with reference to Screenshots 10a and 10b of FIG. 1 is exemplified.

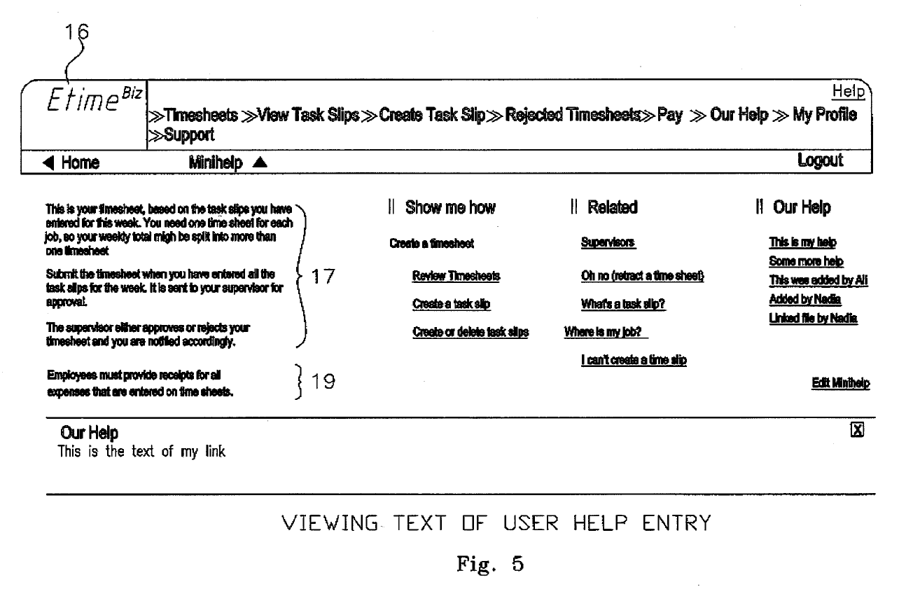

With particular reference to FIG. 3, application 12 comprises a time-cost billing and payment program or application module. FIG. 3 illustrates help window 15 for this application and, more particularly, shows base help data 17 in this instance on the left hand side of the application window 16. If user X elects to add user added help data 19 to this base help data 17 then, subject to access permissions and privileges as previously described with reference to FIG. 2, the user X can open and edit Screen 27 as illustrated in FIG. 4. Having completed entries into the edit screen which will include a Title 21 and Body 22 as well as Creator ID 25, then this user added help data 19 is stored as user added help data sequence 20 together with a unique ID 23 for Title 21 and unique ID 24 for Body 22 thereof. The code then appends user added help data 19 to base help data 17 within the same application window 16 as illustrated in FIG. 5. The detail provided in the user added help data sequence 22 permits control over which users can then access base help data 17 and user added help data 19 and, indeed, who can edit that data as described with reference to the flow chart in FIG. 2.

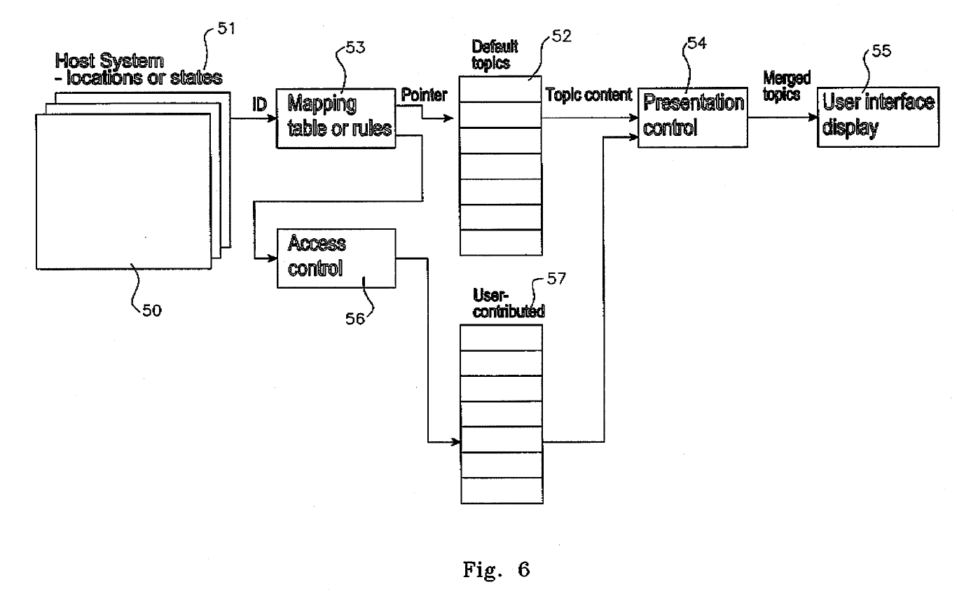

FIG. 6 illustrates a block diagram of modules necessary to give effect to the system described thus far in respect of FIG. 1.

With reference to FIG. 6 any given host system 50 will utilise its operating system to track locations or states 51 of any given application (with reference to earlier embodiments and accounting application). A set of default topics 52 comprising base help data for various locations or states 51 are mapped by mapping table 53 whereby a given location or state 51 maps to a given default topic 52. For any given user X operating within a particular location or state 51 there will be a default topic 52 mapped for that state which will appear under control of presentation control 54 on user interface display 55.

Access control 56 for a given user X operating within a given role and within a particular location or state 51 is mapped to user contributed data 57. The user contributed data 57 may be data which the given user X has contributed or may be data which has been contributed by others operating within the same role and state 51. The user X is able to see the user contributed data 57 on user interface display 55 by the merging of the default topics 52 with the user contributed data 57 by way of presentation control 54 and subject to the role of user X matching with the role and state 51 of the contexts in which both the default topics 52 and user contributed data 57 were created.

In Use

Data Storage and Control

User-contributed elements of online help are stored discretely, such that each one can be managed in isolation to others. The system supports creation, editing and deletion of individual contributions without affecting other contributions. These processes are accessible to any user who has privileges to make embedded help contributions in a given contextual location.

The system associates each embedded help contribution with a specific location or state in the host system. Each such location or state is identified by a unique ID, with each ID mapped to corresponding embedded help contributions.

FIG. 6 shows the end-to-end process for a single user community—deriving from the system of FIG. 1. The process may be repeated for each user community.

System Operation

The system contains default embedded help which is provided by the system developer and delivered with the system. Subject to system privileges which are controlled by an administrator, users can be selectively enabled to create new embedded help content. This is merged with default embedded help such that it is only ever displayed in a contextually-appropriate context.

Multiple user contributions can be made at any given contextual location and the system manages these contributions such that they remain distinct as user-contributed content and capable of being navigated in an efficient manner. Each contribution will have a title and body part, with only the title displayed in the embedded user interface until the user selects a title, whereupon the system will display the body of that contribution.

The system may optionally restrict the viewing of user-contributed help based on privileges that are distinct from normal system-access privileges. That is, users may be selectively prevented from viewing user-contributed help in a given contextual location, even when they can view default embedded help for that location.

Further, in the case where the system has multiple user communities (such as companies), embedded help contributions by each community will be isolated from all other communities.

Hardware Implementation Example

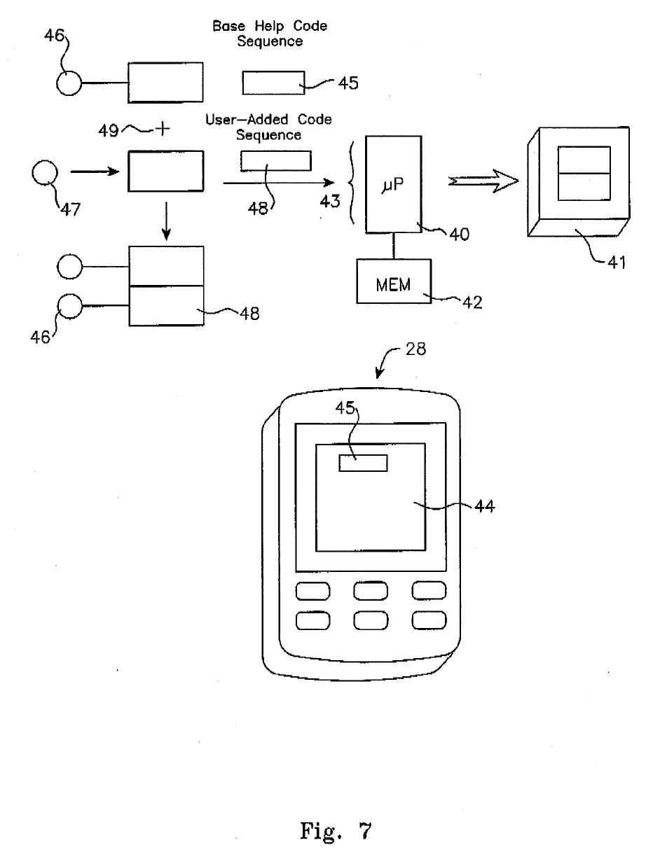

With reference to FIG. 7 there is illustrated hardware components of a handheld computing device (Personal Digital Assistant or PDA) 28. The device includes a processor 40 in communication with display 41, memory 42 and I/O 43. In use an application may display in a window 24 on display 41. The application may include display of an embedded help base help code sequence 45. The base help code sequence 45 will be associated with a user group 46 and a particular context. A member of the user group 47 may elect to add user added code sequence 48 via I/O 43 initially into memory 42. Processor 40 causes the user-added code sequence 48 to be appended by append operation 49 to base help code sequence 45 and stored. The user-added code sequence 48 will be associated with user group 46 in memory 42 thereby to control access and editing rights to user added code sequence 48.

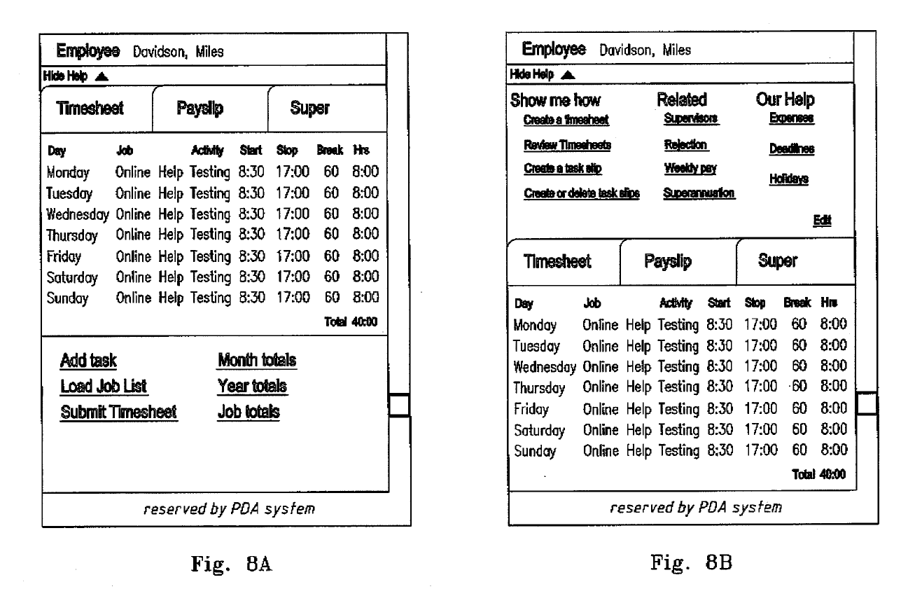

FIG. 8A illustrates a screen shot of the display 41 with a payroll application window open thereon and a “show help” subwindow 50 displayed within it. As illustrated in FIG. 8B activation of subwindow 50 displays embedded help window 51 within window 44. Members of the relevant group can view the components of this embedded help and can append additional user added code sequence as described above with reference to FIG. 7.

A partial PHP code sequence which implements this arrangement is as follows:

```
/********************************************************
********************
* PHP Code
*
*********************************************************
********************
* Retrieve the user's from the database, based on the
username and company.
* Display the menu according to the role
*********************************************************
*******************/
    $sql = “SELECT b.AccessPage FROM tbl_roles a,
tbl_access b WHERE b.AccessID = a.AccessID AND
a.EmployeeID = {$ScrtyID} AND a.CompanyID =
{$ScrtyCompanyID} AND b.AccessName = ‘{$accN}’” ;
    $sql = mysql_query($sql);
    $res = mysql_fetch_assoc($sql);
    if (mysql_num_rows($sql) == 0 &&
$_SESSION[“ScrtyAcc”] != 2 ){
        redirect(“index.php”);
    } else {
        if ($_SESSION[“ScrtyAcc”] == 2){
            require_once “adminmenu.inc.php”;
        } else {
            switch ($accN){
                case ‘Accountant’:
                    require_once “accmenu.inc.php”;
                    break;
                case ‘Customer’:
                    require_once “custmenu.inc.php”;
                    break;
                case ‘Employee’:
                    require_once “empmenu.inc.php”;
                    break;
                case ‘Supervisor’:
                    require_once “supmenu.inc.php”;
                    break;
            }
        }
    }
/********************************************************
********************
* Display help according to user and company.
*
* ‘smarty’ tool provides interface between template and
data retrieval
* Data is retrieved from database and passed to ‘smarty’,
which loads
* display template (‘adminedithelp.tpl’) with correct
data
*********************************************************
********************/
    if ($func == “edit”) {
        $sql = “SELECT * FROM tbl_help WHERE accName =
‘{$accName}’ AND codeName = ‘{$tabCodeName} ’ AND
company_id = ‘{$ScrtyCompanyID}’ ORDER BY id ASC ”;
        $res = mysql_query($sql);
        $array[0] = “0”;
        while ($row = mysql_fetch_assoc($res)) {
```

| | |
|---|---|
| $arrRow[‘title’] | = $row[‘title’]; |
| $arrRow[‘hStrigh’] | = $row[‘hStrigh’]; |
| $arrRow[‘helpUrl’] | = $row[‘hUrl’]; |
| $arrRow[‘hFile’] | = $row[‘hFile’]; |
| $arrRow[‘EmployeeID’] | = |

```
$row[‘EmployeeID’];
            if ($arrRow[‘hStrigh’] != “”)
                $array[ ] = $arrRow;
        }
        $smarty->assign_by_ref(“array”, $array);
        $smarty->assign(“cols”, sizeof($array));
        $helpHead =
file_get_contents(‘text/’.$ScrtyCompanyID.‘_oh_’.$_GET[‘code
Name’].‘.htm’);
        $smarty->assign(“tName”, $_GET[‘tName’]);
        $smarty->display(‘adminedithelp.tpl’);
        exit;
    }
/********************************************************
********************
* Display help pages according to user type.
* In this case, user type is administrator
*
* ‘smarty’ tool used again to load data into template
‘adminhelp.tpl’
*********************************************************
*******************/
    // Administrator help administration page generation.
Display list of pages for selected user type//
    //
    if ($func == “add”) {
        $sql = “SELECT DISTINCT \grave{ }isHelp\grave{ } , \grave{ }accName\grave{ }
,\grave{ }tabName\grave{ } ,\grave{ }codeName\grave{ } FROM tbl_help WHERE accName =
‘{$accName}’ AND company_id = ‘{$ScrtyCompanyID}’ ORDER
BY tabName ASC” ;
        $sql = mysql_query($sql);
        while ($res = mysql_fetch_assoc($sql)){
            if ($res[‘tabName’]){
                $array[‘tabName’] = $res[‘tabName’];
                if ($res[‘isHelp’])
                    $array[‘tabStatus’] = “Yes”;
                else $array[‘tabStatus’] = “No”;
                $array[‘tabCodeName’] = $res[‘codeName’];
                $smarty->append(“array”, $array);
            }
        }
        $smarty->display(‘adminhadd.tpl’);
        exit;
    }
    // Administrator help administration main page
generation. Display list of user types for select it to
edit//
    //
    $sql = “SELECT * FROM tbl_help WHERE company_id =
‘{$ScrtyCompanyID}’ ORDER BY accName ASC”;
    $res = mysql_query($sql) ;
        while ($one_row = mysql_fetch_assoc($res)){
          $array[$one_row[‘accName’]][‘is’] += 1;
          if ($one_row[‘isHelp’] != “”)
            $array[$one_row[‘accName’]][‘no’] += 1;
    }
    $smarty->assign_by_ref(“array”, $array);
    $smarty->display(‘adminhelp.tpl’);
```

### IN SUMMARY

Embodiments of the invention include a method and apparatus for enabling users of embedded online help to merge new content into the help.

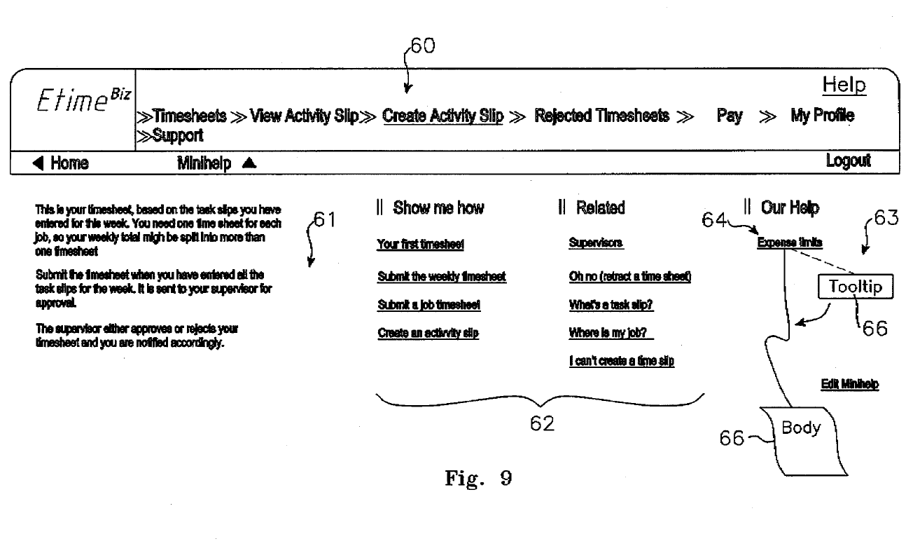

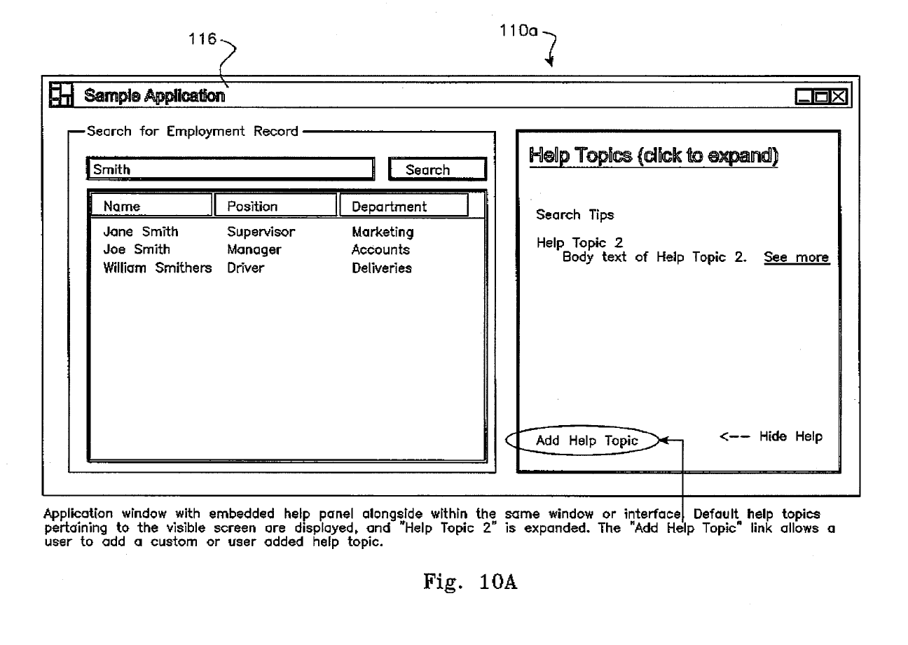

By way of summary and with reference to FIG. 9 and FIGS. 10A, B, C (which provide an example sequence of the sequence of FIG. 1):

FIG. 9 illustrates a screenshot of content of part of an application window 60 wherein embedded help content 61 is displayed in the same window as an application (in this instant, a time cost billing application). In addition to base help data 62, there exists user added data 63 in the form of a title 64 which, in this instance, is hyperlinked to a body of user added help data 65. In a particular form a tool tip 66 may appear if the user causes their mouse cursor to hover over the title 64. The tool tip 66 can be longer than the title 64 and provide more detailed information to allow the user to decide whether to open body 65. This can be useful example where the help data links to an external file (for example a PDF file) and the user would like a little more information as to how relevant the date in the link might be before opening the link.

A sequence for adding further user added help data is illustrated in FIGS. 10A, B, C wherein like components are numbered as for FIG. 1 except in the 100 series. The application in the instance of FIG. 10 is an employment record application however, this is by way of example and could equally be a time cost billing application as exemplified in FIG. 9.

In FIG. 10A, there is illustrated an application window with embedded help panel alongside within the same window or interface. Default help topics pertaining to the visible screen are displayed, and ‘Help Topic 2’ is expanded. The ‘Add Help Topic’ link allows a user to add a custom or user added help topic.

With reference to FIG. 10B, there is illustrated a help panel displaying user added help topic retrieved from database.

FIG. 10C illustrates second user added help topic added to help panel and expanded. Further help topics related to this window can be continued to be added. As illustrated in the table, hyperlinks to other data (including web based data) can be included as part of the body. Characteristics of the systems of FIGS. 9 and 10 include:

In preferred embodiments the invention provides a system where users of online help embedded into a device or software can create new help content that is merged with the existing base help content.

The system may have any one or more of the following characteristics:

Individual contributions to any given location can be viewed in isolation from each other.

Contributions have a pertinent summary word or phrase that is used to hyperlink access to the body of the contribution, and this summary phrase is merged into the existing set of hyperlinks that are used for navigation in the online help. These hyperlinks control which, if any, user-created content is displayed.

Contributions are merged such that their displayed is consistent with the existing content User contributions are controlled in isolation from default help such that the system can restrict access to it based on user or group permissions.

The system can be configured to give or withhold permission for users or groups to create new contributions.

The above describes only some embodiments of the present invention and modifications, obvious to those skilled in the art, can be made thereto without departing from the scope of the present invention.

What is claimed is:

1. An embedded help system for a software application; said facility providing embedded help data to a user in response to a help query from said user; said embedded help data comprising base embedded help data and user added embedded help data; said embedded help data pertinent to the operation of said software application.

2. The system of claim 1 wherein said software application includes a user interface and said embedded help data is embedded in said user interface.

3. The system of claim 1 wherein said user added help data is merged with said base help data.

4. The system of claim 1 wherein said user added help data comprises one or more distinct contributions.

5. The system of claim 1 wherein said software application can be perceived by said user as comprising a set of one or more contextual locations

6. The system of claim 4 wherein said help data attaches to selected ones of contextual locations whereby said help data is pertinent to said contextual locations.

7. The system of claim 5 wherein said user added help data remains distinct from said base help data.

8. The system of claim 1 wherein individual contributions to any given location can be viewed in isolation from each other.

9. The system of claim 8 wherein each contribution has a pertinent title and summary word or phrase that is constructed as a hyperlink which when activated allows access to the body of the contribution.

10. The system of claim 9 wherein said title is merged into the existing set of hyperlinks that are used for navigation in the online help.

11. The system of claim 10 wherein said hyperlinks control which, if any, user-created content is displayed.

12. The system of claim 1 wherein contributions are merged such that their display is consistent with the existing content.

13. The system of claim 1 wherein each user contribution is controlled in isolation from default on base help data such that the system can restrict access to said contribution based on user or group permissions.

14. The system of claim 1 wherein said system can be configured to give or withhold permission for users or groups to create new contributions.

15. The system of claim 1 wherein presentation and management is an integral part of said application.

16. The system of claim 15 wherein said help data is maintained separately from the executable code of said application.

17. The system of claim 16 wherein a contributor of said help data uses said application and notes the page name at each context of entry of said help data thereby to match by way of a key said help data with said application within said context thereby to permit addition of said help data to said application independent of the writing of said executable code of said application.

18. A method for enabling users of embedded online help data to merge new content or user added help data into the help data; said embedded online help data comprising help data embedded in a user interface of an application.

19. The method of claim 18 where users of online help embedded into a device or software can create new help content that is merged with the existing help content.

20. A method for provision of help data to a user of an application; said method comprising display of base help data embedded in an application window; said base help data pertinent to the context of said application; permitting said user to add user added help data to said application window subject to user permission.

21. The method of claim 20 wherein said user permission is based on role of said user.

22. The method of claim 20 wherein said user added help data is provided as a first component and a second component; said first component hyperlinked to said second component.

23. A memory having a computer program stored therein, said computer program capable of being used in connection with an application; said application displayable in a window on a display driven by a processor in communication with said memory; said memory comprising:
a first memory portion physically configured in accordance with computer program instructions to display help data embedded in an application window;
a second memory portion physically configured in accordance with computer program instructions that will enable a user of said application to open an editing window for editing of user added help data;
said application window comprising a video image of a display; said processor driving said display so as to present help data and user added help data derived from said user together in said application window.

24. A data sequence comprising a base help code sequence which is linked in computer memory with a user added code sequence for display in an application window; said user added code sequence generated by an editor program which opens in said application window on instruction from said user.
